(19) United States
(12) Patent Application Publication
(10) Pub. No.: US 2002/0119796 A1
(43) Pub. Date: Aug. 29, 2002

(54) System and method for improved mobile communication admission and congestion control

(75) Inventor: Vieri Vanghi, San Diego, CA (US)

Correspondence Address: David E. Bennett, Coats & Bennett, P.L.L.C., Suite 300, 1400 Crescent Green, Cary, NC, 27511, US

(73) Assignee: Telefonaktiebolaget LM Ericsson

(21) Appl. No.: 09/750,296

(22) Filed: Dec. 29, 2000

(51) Int. Cl. H04B 7/00

(52) U.S. Cl. 455/522; 455/13.4; 455/69

(57) ABSTRACT

A wireless communication system is provided for improving the quality of service and capacity utilization by dynamically adjusting optimum transmission signal power levels in response to changes in transmission signal and mobile station characteristics, so as to maintain a system outage probability below a desired level. A code division multiple access (CDMA) mobile communication system improved control and capacity utilization are achieved by dynamically adjusting the admission control threshold and/or congestion detection threshold to compensate for variations in the characteristics of the signals and mobile station loading of a base station. In one embodiment, a CDMA base station and control system may include a transmission power detector or sampler coupled to a power control of a transceiver and a transmission power estimator. The power estimator may be a K'th moment estimator and be coupled to an admission control threshold estimator and a capacity estimator. The capacity estimator may be coupled to an admission and/or congestion controller. In general, the CDMA forward link admission control and congestion control mechanisms for admitting or releasing a mobile station from a base station cell operate to dynamically self-configure their admission control threshold and/or congestion detection threshold in order to maintain an outage probability below the desired level. In one embodiment, the average total base station transmission power of a sample set of recent system operation and the variability of the base station transmission power within the sample set are used to dynamically self-configure the system. Therefore, the present invention provides a more efficient method for obtaining optimum quality of service and capacity utilization based on determining a desired maximum outage probability and configuring the base station control system to dynamically self-configure its admission and/or congestion thresholds to meet the outage probability constraints.

### BACKGROUND OF THE INVENTION

1. Technical Field

The present invention relates generally to wireless communication systems, and more particularly to improving the quality of service and capacity of a wireless communication system.

2. Related Art

The quality of service and capacity adjustments of fast power controlled wireless communication systems are not well designed to continuously attain the best quality of service with the most mobile stations (and thereby the most users) capacity across variations in system parameters related to mobile station mobility. For example, in cellular multiple access communication systems where large numbers of mobile stations (users) share the same carrier frequency, such as code division multiple access (CDMA), a base station includes multiple transceivers each have a transmitter with a predetermined maximum output power capability, for example 10 watts. This maximum output power is shared by a pilot channel and multiple traffic channels. The pilot channel provides information to all mobile stations in the base station cell area so that the mobile stations can accurately demodulate incoming traffic signals from the base station. The CDMA systems are typically configured so that a system operator may from time-to-time manually set a threshold that will be indicative of the maximum number of mobile stations the base station will support. This threshold, typically expressed in Watts which the base station transmit power (or equivalent metric) is compared against, may be based on the system operator's assessment of historical experience with various system performance parameters, for example, an average acceptable base station transmit power and power distribution derived by signal sampling and analysis. These manually set maximum base station transmit power levels may correlate to a general range of system outage probability and are typically set infrequently by the system operator, for example once every few months, and do not take into consideration contemporary changes in the system traffic.

In one CDMA system, using for example cdma2000, the acceptable number of mobile stations supported by a particular base station (and thereby users) and acceptable system outage probability that may occur is determined by setting the ratio of the pilot channel minimum required transmit chip energy to the total transmit power spectral density (Pilot (Ec/Ior))for the transmitters of each base station in the system. This method may be used instead of monitoring simply the total transmit output power density because of the importance of the pilot signal in ensuring proper system operation, including signal demodulation by the mobile stations. Thus, in this case the CDMA forward link (base station to mobile station) signal may include the common pilot signal multiplexed in code domain with other channels (e.g., traffic channels) and have a meaningful outage probability established and configured manually by a system operator (e.g., a system administrator) based on, for example, the pilot channel minimum required transmit chip energy relative to the total transmit power spectral density, Pilot(Ec/Ior).

In such wireless communication systems the active mobile stations (e.g., mobile telephone) in the base station coverage cell use the pilot signal for various functions such as channel estimation. Channel estimation consists of received signal carrier phase offset, received signal carrier frequency offset, and channel propagation delay estimation. The carrier signal phase and frequency offsets need to be estimated and compensated for by the mobile station receiver phase rotator and automatic frequency controller, respectively, to allow for coherent signal detection. The channel propagation delay needs to be estimated to allow for optimally adjusting the timing of the signal sampling device. Any imperfect estimation of the carrier phase and frequency offsets, and signal sampling time will negatively affect mobile station receiver performance. Thus, since all operations above rely on a high quality received pilot signal, it is important to maintain the transmit ratio Pilot(Ec/Ior) above a certain level to guarantee reliable demodulation of the forward traffic channel. When the Pilot(Ec/Ior) falls below such level, forward link traffic channel demodulation performance degrades because the traffic channel Eb/Nt received at the mobile station demodulator input required to achieve a desired frame error rate (FER) can increase substantially. In such a scenario, the forward link closed loop power control function is such that the majority of the mobile stations would request an increase in the forward traffic channel transmit power, therefore increasing the cell total transmit Ior and further decreasing the pilot signal to total forward transmission signal ratio; Pilot(Ec/Ior). Thus, this power adjustment process can cause excessive system capacity consumption and may degenerate to system outage because of its positive feedback methodology.

Various conventional admission control methods may avoid drifting into system congestion (i.e., a situation in which the total transmit power is such that the outage probability is significant) by comparing an estimation of the short term average Pilot(Ec/Ior) against the manually set fixed, albeit configurable, minimum admission threshold, Pilot(Ec/Ior)min. As suggested above, the admission threshold is manually set to a particular value by the system operator and remains fixed during system operation unless reset by the system operator. If the current estimate is below the admission threshold, incoming requests for traffic channel setup by additional mobile stations are denied. Further, if the estimate falls below a fixed, albeit configurable, congestion threshold, which is typically lower than the admission threshold, the system is said to be in congested state and actions are taken aimed at reducing the current load. That is typically accomplished by shedding load, that is, relocating selected active users to an alternate CDMA channel with available residual capacity, and/or releasing the traffic channel connection of selected users, and/or decreasing data rate of selected users, or other equivalent actions. The congestion threshold is also manually set to a particular value (or difference from the admission threshold) by the system operator and remains fixed during system operation unless reset by the system operator.

Previously known methods for controlling forward link signal quality and mobile station capacity suffer from the fact that the fixed admission (Pilot(Ec/Ior)min) and congestion thresholds are established for a given outage probability which is based on historical system operation and mobile station traffic patterns that may or may not be the same as those for contemporary system operation. As the base station system traffic characteristics vary dynamically over time the fixed admission and congestion threshold result in a varying outage probability. This unnecessarily limits the capacity of the system and increases the likelihood of system outage because future system mobile station traffic experience may vary significantly from that of the not so recent past. The outage probability varies with the characteristics of the base station signal traffic over time. Some of the various signal traffic characteristics that can affect the outage probability and necessarily change dynamically over time include, for example, mobile station (user) mobility, mobile station distribution across the base station cell area, short term voice activity, and the intensity of short term data bursts. The variability of these type of characteristics over time changes the variability of the transmit Pilot(Ec/Ior), which in turn results in a variation in the outage probability. Therefore, the conventional approach of using fixed system admission and congestion control that is manually set by a system operator at relatively infrequent intervals may result in maintaining less then optimum base station signal outage probability, quality of service, and mobile station capacity utilization.

### SUMMARY OF THE INVENTION

The present invention is directed to a system and method for improving the quality of service and capacity utilization of a wireless communication system by dynamically adjusting optimum output power levels in real time in response to changes in transmission signal and mobile station characteristics, so as to maintain a system outage probability below a desired level. In a code division multiple access (CDMA) mobile communication system improved quality of service control and capacity utilization are achieved by dynamically adjusting the admission control threshold and/or congestion detection threshold in real time to compensate for variations in the characteristics of the signals and mobile station loading of a base station transmitter. Accordingly, the mobile communication self-configuring admission/congestion control system in general may include a transmission power estimator module, a congestion control module, an admission control module, and a call control module. In an exemplary embodiment, the modules may be distributed between a base station controller (BSC) and a radio base station (RBS). For example, a CDMA base station and control system may include a transmission power detector or sampler coupled to a power control of a transceiver and a transmission power estimator. The power estimator may be a K'th moment estimator and be coupled to an admission control threshold estimator and a capacity estimator. The capacity estimator may be coupled to an admission and/or congestion controller.

In general, the CDMA forward link admission control and congestion control mechanisms for admitting or releasing a mobile station from a base station cell operate to dynamically self-configure their admission control threshold and/or congestion detection threshold in order to maintain an outage probability below the desired level. The thresholds may be continuously self-adjusted in real time to compensate for variations in, for example, the statistical distribution of the total base station transmission power recently experienced. In one embodiment, the average total base station transmission power of a sample set of recent system operation and the variability of the individual base station transmission power within the sample set are used to dynamically self-configure the system.

More particularly, the CDMA admission and congestion control system operates such that the power detector may send a moment estimator a sample of the base station transmit power. The power detector may be analog or digital and measure, for example, the baseband signal. The transmission power estimator may collect multiple transmit power samples using power information from the power detector, each sample taken over a predetermined time period during which the total power is relatively unchanged. For example, each transmit power sample may be measured over the time period of a power control group (e.g., 1.25 ms); i.e., during an interval in which the forward link closed loop power control function is not changing the transmission power of the individual traffic channels that, together with the fixed power pilot channel, make up the total base station transmit power. In this time period the transmission power will be relatively unchanged except for changes in the chip-level peak to average power of the CDMA signal.

The transmit power estimator may then use a predetermined number of power samples to dynamically estimate the first K moments (K>1) of the transmit power to determine the optimum admission and/or congestion thresholds to be used by the system given the present state of the signals and mobile station locations. The optimum admission and/or congestion threshold is the one that corresponds to the maximum tolerable probability of outage, that is, the probability that the instantaneous base station transmit Pilot(Ec/Ior) falls below the desired minimum threshold. In the case of K=2, the real time average base station transmission power and the variance of the base station transmission power are dynamically determined and used by the threshold estimator and the capacity estimator to reset the admission threshold and/or congestion threshold. For example, using the first two moments, the average and variance of the base station transmission power, the threshold estimator and the capacity estimator are able to dynamically set a threshold(s) based on a desired outage probability that takes into consideration both the contemporary instantaneous average transmission power and deviation (e.g., standard deviations) from the average transmission power of the base station. Additional (higher) moments other than the average and variance would allow for a more reliable estimation of the probability of outage and therefore may also be used to dynamically set the threshold(s). In other words, the threshold estimator may dynamically compute contemporary admission control thresholds based on the average value the base station transmission power should have for the outage probability to be equal a desired outage probability, given the estimated K moments (e.g., K=2, 3, . . . ). In one variation, the contemporary admission control threshold(s) may be filtered by, for example, a low pass filter such as a non-linear low pass filter with fix slew rate.

In any case, the dynamically generated contemporary admission control thresholds and/or congestion control thresholds are provided to the admission and/or congestion controllers to determine whether more traffic channels (i.e., mobile stations) may be set up on the base station transceiver (i.e., admission) or that a number of presently set up traffic channels should be shed from the base station transceiver. For example, in the case of a request for mobile station admission, the contemporary admission control threshold(s) may be compared against the estimated first moment of the base station transmission power to compute the residual base station capacity. The residual base station capacity may then be used by the admission and/or congestion controller to determine whether to add one or more mobile stations and their respective traffic channels to the base station transmitter total transmission power, based on contemporary system traffic experience.

Therefore, the present invention provides a more efficient method for obtaining a desired quality of service with optimum capacity utilization based on a desired maximum outage probability by configuring the base station control system to dynamically self-configure its admission and/or congestion thresholds to meet the outage probability constraints.

### BRIEF DESCRIPTION OF THE DRAWINGS

FIG. 1 is a block diagram of an exemplary mobile communication system including a mobile station, a base station transmitter, a base station controller, and a mobile switching center which may be configured to automatically self-configure the mobile station traffic admission and/or congestion control in real time, according to the present invention.

FIG. 2 is a conceptual block diagram indicating the general aspects of a mobile communication system to self-configure the mobile station traffic admission and/or congestion control in real time, according to one embodiment of the present invention.

FIG. 3 is a block diagram of a mobile communication system that self-configures the mobile station traffic admission and/or congestion control in real time, according to one embodiment of the present invention.

FIG. 4 is a block diagram of exemplary modules that may be included in a mobile communication system that self-configures the mobile station traffic admission and/or congestion control in real time, according to another embodiment of the present invention.

FIG. 5 illustrates a flow chart of one method for self-configuring a mobile communication system's mobile station traffic admission and/or congestion control in real time, according to one variation of the present invention.

### DESCRIPTION OF THE PREFERRED EMBODIMENTS

The present invention is directed to a system and method for improving the quality of service and capacity utilization of a wireless communication system. The preferred embodiments are directed to a CDMA mobile communication system but may prove useful in other mobile communication systems. In any case, the CDMA system of the present invention is configured to dynamically adjust the optimum output power levels of base station transmitter(s) in real time to account constant changes in transmission signal and mobile station characteristics. The system dynamically self-configures its power transmission levels in real time to meet a desired system outage probability. The outage probability is manually input into the system by a system operator at system commissioning, and needs not be reconfigured because, for example, of variations of the traffic load profile. As a result, the present invention provides a more efficient manner of implementing mobile station traffic admission and/or congestion control that optimizes the power output level and system traffic capacity of the mobile communication system and eliminates the need for regular manual input by a system operator for setting admission and/or congestion control thresholds.

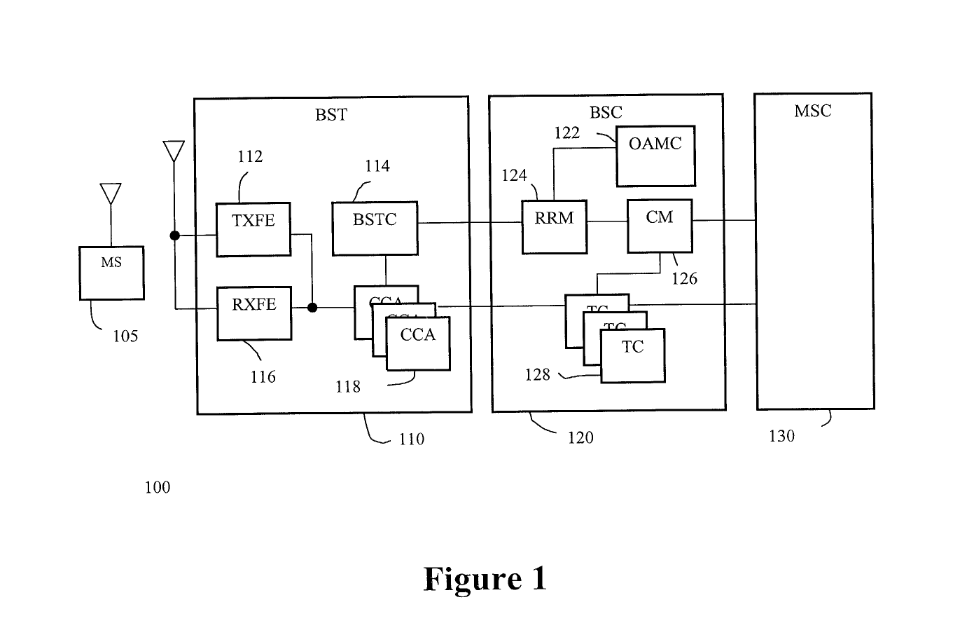

When referring to FIGS. 1-5 and the description of the various preferred embodiments which follow, certain terms and acronyms are used and are defined in the list below for convenience.

| | |
|---|---|
| MS | Mobile Station |
| TXFE | Transmit Front End |
| RXFE | Receive Front End |
| CCA | Circuit Card Assembly |
| BSTC | Base Station Transceiver Controller |
| CM | Call Manager |
| TC | Transcoder |
| OAMC | Operation Administration and Maintenance Center |
| BST | Base Station Transceiver |
| BSC | Base Station Controller |
| RRM | Radio Resource Manager |
| MSC | Mobile Switching Center |
| $Pilot \frac{{E}_{c}}{{I}_{or}}$ | Pilot transmit chip energy to total transmit power spectral density ratio. |
| ${Pilot \frac{{E}_{c}}{{I}_{or}} \vert}_{min}$ | Required minimum pilot transmit chip energy to total transmit power spectral density ratio. |
| P_{PIL} | Pilot transmit power. |
| P_{TX,MAX} | Maximum allowable total transmit power. |
| \hat{P}_{TX} | Estimated short term average of |
| | total transmit power. |
| \hat{μ} | Adaptive call admission threshold, |
| | against which \hat{P}_{TX} is compared. |
| P_{OUTAGE} | ${Probability that Pilot \frac{{E}_{c}}{{I}_{or}} \leq Pilot \frac{{E}_{c}}{{I}_{or}} \vert}_{min} .$ |

FIG. 1 generally depicts, in block diagram of form, a wireless communication system 100 which may beneficially employ the improved control system according to the present invention. In a preferred embodiment, the wireless mobile communication system is a CDMA cellular radio telephone system including one or more cellular base station transceivers and mobile stations. However, as one of ordinary skill in the art will appreciated, the invention can be implemented in any wireless communication system which may include any type of mobile communication device such as a mobile telephone, personal digital assistant (PDA), web pad, etc.

As illustrated in FIG. 1, the wireless communication system 100 may include a mobile station (MS) 105, a base station transmitter (BST) 110, a base station controller (BSC) 120, and a mobile switching center (MSC) 130 which may be configured to automatically self-configure the mobile station traffic admission and/or congestion control in real time so as to maintain a predetermined outage probability regardless of continuous changes in the signal and traffic characteristics. In a preferred embodiment the BST 110 implemented in base stations may include a transmit front end (TXFE) 112 and a receive front end (RXFE) 116 coupled to a base station antenna. The TXFE 112 and RXFE 115 are coupled to a plurality of transmit back end circuit card assembly (CCA) 118 which is coupled to a base station transceiver controller 114.

The base station transceiver 110 is coupled to the base station controller 120. A radio resource manager (RRM) 124 in the BSC 120 is coupled to the BSTC 114 in the BST 110. A plurality of transcoders (TC) 120 in the BSC 120 are coupled to the plurality of CCAs 118 in the BST 110. The BSC 120 may also include a operation administration and maintenance center (OAMC) 122 and a call manager 126 coupled to the RRM 124. Further, the CM 126 may be coupled to the plurality of TCs 128. The CM 126 and plurality of TC 128 may be coupled to the MSC 130.

In operation the base station with its related components and the mobile station 105 may be implemented to support RF communications as defined in, for example, the document titled by TIA/EIA/IS-95A (July, 1993) or similar documents available from the Telecommunications Industry Association (TIA), 2001 Pennsylvania Avenue, Washington, D.C. 20006. In relevant part, for one preferred embodiment the CCA 118, BSTC 120, RRM 124, and CM 126 are configured to provide improved traffic admission and/or congestion control according to the present invention. In general the system operates such that the BSTC continuously samples the output power of the base station and calculates certain characteristics, for example the average output power and variance of the output power for a group of samples. Next, the RRM 124 takes this information to dynamically generate and set a contemporary output power threshold and/or congestion threshold to achieve a predetermined outage probability. This information is provided to the CM 126 to determine whether to admit additional mobile stations (i.e., additional traffic channels) or take steps to reduce traffic congestion. Requests to admit new mobile stations may be received from the MSC 130.

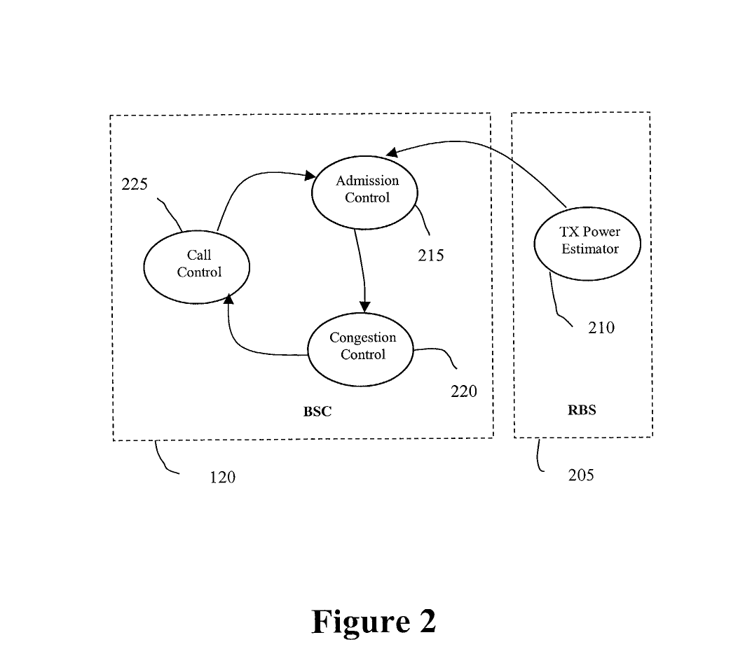

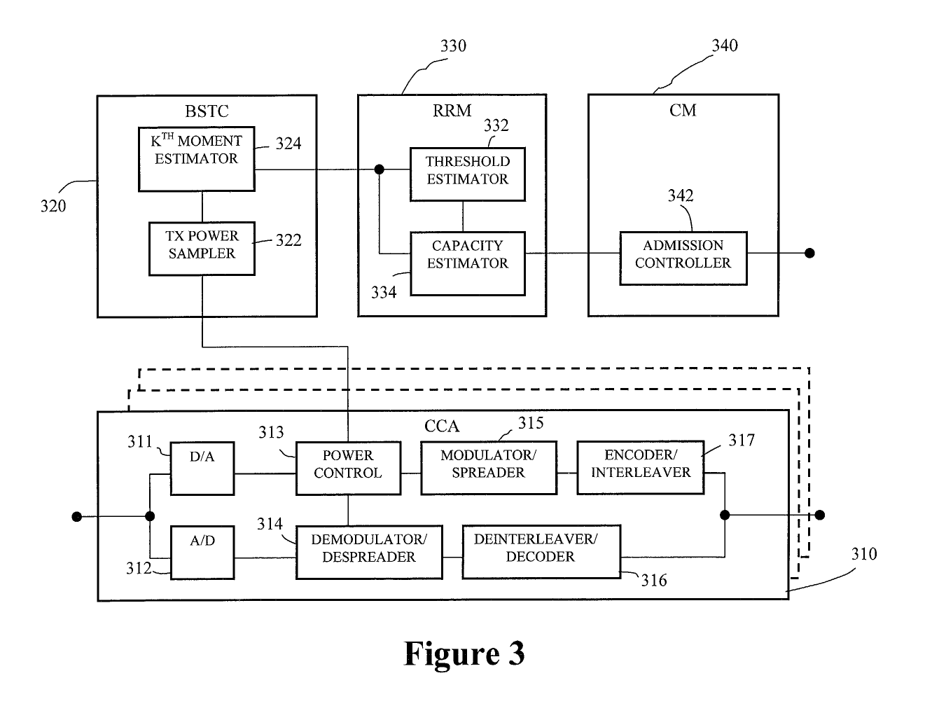

Referring now to FIG. 2, a conceptual block diagram is provided including the general aspects of a mobile communication system configured to self-adjust the mobile station traffic admission and/or congestion control in real time. In a preferred embodiment, the communication system is a CDMA mobile communication system having improved quality of service control and capacity utilization achieved by dynamically adjusting the admission control threshold and/or congestion detection threshold in real time to compensate for variations in the characteristics of the signals and mobile station location and loading of a radio base station (RBS) 205 transmitter. The mobile communication self-configuring admission/congestion control system in general may include a transmission (TX) power estimator module 210 included in the RBS 205. The TX power estimator may continuously sample the total transmit power and use these samples to derive traffic signal characteristics such as the recent average and variation of total power produced by the base station. This information may then be provided to an admission control module 215 to automatically determine the appropriate admission blocking threshold as derived from the contemporary samples. The system may also include a congestion control module 220 for managing congestion control. In a variation, the sampled contemporary transmit power information could be provided to only the admission control module 215 or the congestion control module 220 so that only one of the two functions might have real time automatic threshold adjustment. In the case of the congestion control module, the base station residual capacity may generated and used by the congestion control module 220 to determine if the present base station transmitter load is greater than a desired load. The admission control module 215 and/or the congestion control module 220 then instructs a call control module 225 whether addition traffic can be added and/or congestion relief actions need to be take to achieve a desired system outage probability. In the exemplary embodiment provided in FIG. 2, the modules may are distributed between the BSC 120 and the RBS 205 in a particular manner. However, one skilled in the art recognizes that the modules could be located at different locations than those shown in this example and still operate according to the invention. Another more specific embodiment and arrangement of the various modules as integrated into a system such as that shown in FIG. 1, is provided in FIG. 3.

Referring now to FIG. 3, a block diagram is provided for a particular preferred embodiment of a mobile communication system including the real time dynamic self-configuring mobile station traffic admission and/or congestion control according to the present invention. The system may include one or more base station transceiver circuit card assembly (CCA) 310, a BSTC 320, a RRM 330, and a CM 340. According to this embodiment a CDMA admission and congestion control system may be included in the BSTC 320, RRM 330, and CM 340. The CCA 340 may include a transmitter and receiver path with components. The CCA 340 corresponds in this exemplary embodiment to one forward/reverse traffic channels pair assigned to one given mobile station. The transmitter path may include a D/A converter 311 for converting an outgoing transmission signals from digital to analog and be couple to a power control module 313. The power control module is coupled with the receiver demodulator module 314. The power control module adjusts the transmit power of the forward traffic channel as determined based on power control information fed back by the mobile station and multiplexed together with user data and other control information onto the reverse traffic channel. The power control 313 is coupled to modulator/spreader 315 and encoder/interleaver 317 in the transmitter path. The modulator/spreader 315 and encoder/interleaver 317 format information into the preferred signal format, CDMA in spread spectrum, prior to transmission to the mobile stations 105. The power control level is also coupled to the demodulator/despreader 314 in the receiver path so that it may receive transmit power level change request information from the mobile stations 105. The receiver path may further include a deinterleaver/decoder 316 and A/D converter 312 for receiving an analog CDMA spread spectrum signal from the mobile stations 105 and converting it to a despread decoded digital signal.

The power control 313 of all CCA 310 elements of each transceiver may be coupled to transmit power sampler 322 that may be located in the BSTC 320. The power control 313 elements inform periodically the transmit power sampler 322 of the transmit power of each CCA 310, that is, of each forward traffic channel. The transmit power sampler may add up the samples from all the power control modules to determine a sample of the aggregate (total) base station forward traffic channels transmit power. The transmit power sampler may be coupled to a K'th moment estimator 324 that may also be located in the BSTC 320. The K'th estimator may be coupled to a threshold estimator 332 and a capacity estimator 334, both of with may be located in the radio resource manager (RRM) 330. The capacity estimator may also be coupled to an admission controller 342 that may be located in the call manager (CM) 340. The admission controller may be in one variation an admission and/or congestion controller. Although various modules, such as the K'th moment estimator 324 and threshold estimator 332, are illustrated in the present embodiment as being located within a particular part of the communication system, one skilled in the art would recognize that they may be located anywhere as long as they can provide their functionality to the communications system for providing dynamic real time admission and/or congestion control adjustments.

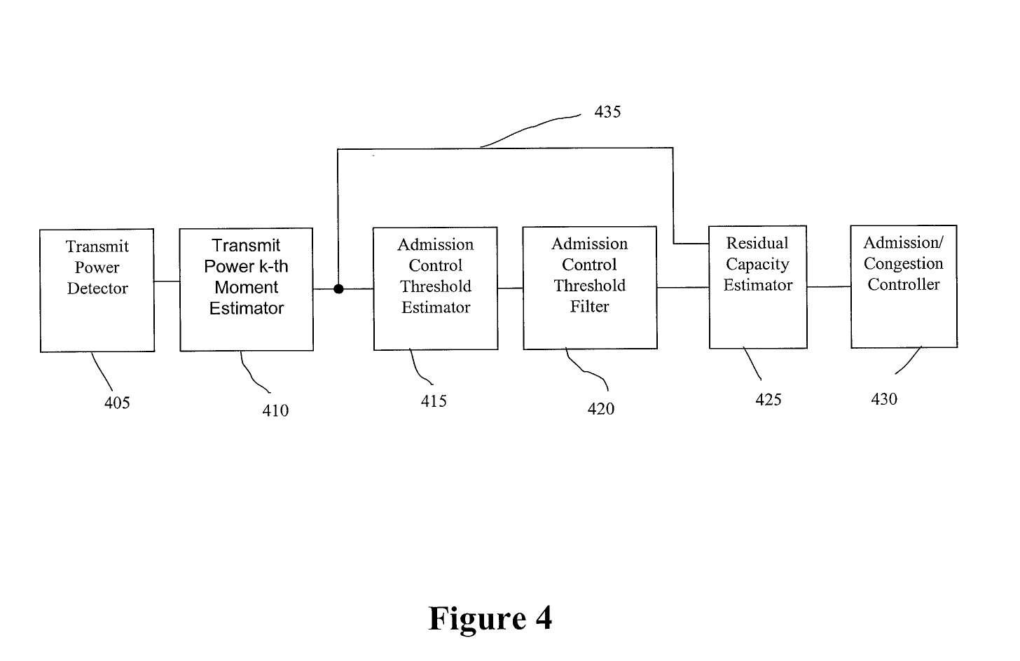

Referring now to FIG. 4, another preferred embodiment of the present invention is provided. FIG. 4 illustrate a block diagram of exemplary modules that may be included in a real time self-configuring wireless communication traffic admission and congestion control system. This system may be coupled to the base station so as to dynamically adjust the maximum amount of mobile traffic supported by the base station and may include a transmit power detector 405 coupled to a transmit power K'th moment estimator 410. The power detector may be analog or digital and measure, for example, the base band signal. The K'th moment estimator 410 may be coupled to an admission control threshold estimator 415 and a residual capacity estimator 425. The admission control threshold estimator 415 and a residual capacity estimator 425 may both be coupled to an admission control threshold filter 420. And the residual capacity estimator 425 may be further coupled to an admission/congestion controller 430.

In operation, the CDMA forward link admission control and congestion control mechanisms operate to admit or release one or more mobile stations from a base station cell by dynamically self-configuring the admission control threshold and/or congestion detection threshold so as to maintain an outage probability below the desired level. One or more thresholds may be continuously self-adjusted in real time to compensate for variations in, for example, the average total base station transmission power recently experienced for a given traffic and signal pattern. In some preferred embodiment, the average total base station transmission power of a sample set of total transmit power from recent system operation and the variability of the individual base station transmission power within the sample set are used to dynamically self-configure the control system. In other preferred embodiments admission and/or congestion thresholds may be dynamically adjusted using consideration of other factors such as the skewedness of the total base transmit power distribution, as characterized by its 3^{rd} order moment (K=3).

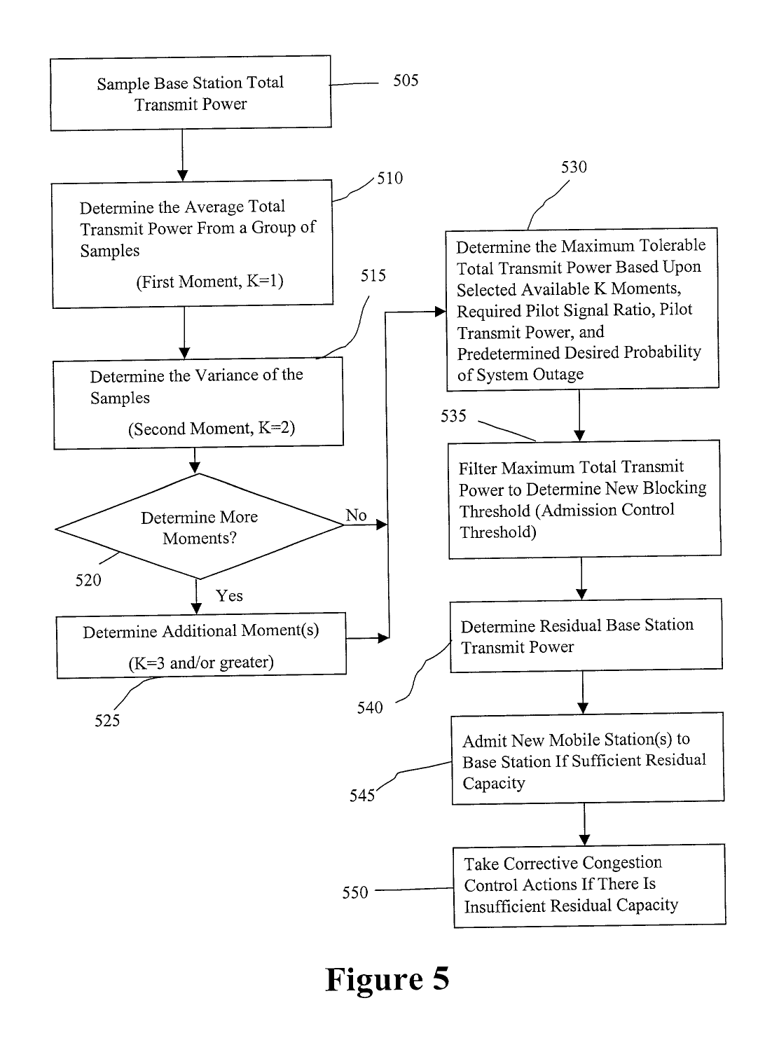

Referring now to FIG. 5, one preferred method of operation for the present invention will be described in detail. First, at step 505, the transmit power detector 405 (sampler 322) may continuously sample the transmit power from the power control 313 to enable assessment of the contemporary total transmit power in real time and its characteristics over time. These samples may be filtered. For example, the transmit power detector 405 may sample the total transmit power, P_{TX}, with period T_{S}. The samples corresponds to the total transmit power measured by a channel modulator device over a power control group (e.g., 1.25 ms), since the transmit power is constant over such interval the chip-level peak to average of the CDMA waveform are ignored. Next, at step 520, the transit power K'th moment estimator 410 determines the average total transmit power from a group of samples. The samples may be filtered by, for example, a single pole infinite impulse response (IIR) low pass filter with time constant τ>>T_{S}, such as:

$$H [ D = {T}_{S} ] = \frac{1 - ( 1 - {2}^{- γ} )}{1 - ( 1 - {2}^{- γ} ) \cdot D} , \qquad \text{Eq. 1-1}$$

where τ=−T_{S}/1n[(2^{-γ}−1)/2^{-γ}].

In the time domain, the output of this filter at time n, \hat{P}_{TX}(n), can be described in terms of the output of the filter at time n−1, \hat{P}_{TX}(n−1), and the input of the filter at time n, P_{TX}(n), by the equation

\hat{P}_{TX}(n)=\hat{P}_{TX} (n−1)−2^{-γ}\hat{P}_{TX}(n−1)+2^{-γ}\hat{P}_{TX}(n). Eq. 1-2

The filter time constant shall also be such that the short term total transmit variations due to fast forward link power control, voice activity, and data burstiness are smoothed out, but must be small enough such that transmit power changes due to additional traffic channels setup in the cell can be rapidly detected. Thus, an average total transmit power \hat{P}_{TX}(n) is derived from a predetermined number of samples for the first moment, K=1.

Next, at step 515, the transmit power K'th moment estimator may determine the variance of the total transmit power for the predetermined group of samples taken by the transmit power detector 405. For example, the transmit power estimation function may estimate the second order moment of the transmit power from the sample measurements obtained in the last 2τ sec, as in:

$${σ}_{{P}_{TX}}^{2} ( n ) = {\sum }_{i = - ⌈ 2 τ / {T}_{S} ⌉}^{0} \frac{{[ {\hat{P}}_{TX} ( n - i ) - {P}_{TX} ( n - i ) ]}^{2}}{⌈ \frac{2 τ}{{T}_{S}} ⌉} . \qquad \text{Eq. 1-3}$$

Then, at decision step 520, it is determined whether any additional moments (K>2) of the sample total transmit power are to be generated. If so, than at step 525, the transmit power K'th moment estimator 410 will determine the additional moments. Some examples of higher order moments useful in dynamically generating admission and/or congestion thresholds include, for example, K=3, as indicated above and directed to skewedness of the probability distribution being different than a gaussian distribution.

One reason for using higher order moments is that the transmit power probability distribution is not typically perfectly gaussian and therefore a more accurate determination of the actual outage probability may be obtained by calculating additional moments beyond K=2. Since, in the general case, the outage probability is defined as P(X<=x) (once you define an appropriate metric X such as the Pilot(Ec/Ior)), such probability depends on the distribution function of the random variable X. If X is gaussian, or nearly gaussian, the distribution function may be fairly accurately characterized by the first two moments, and the formula presented herein in equations 1-1 to 1-5 can be used to find P(X<=x). However, often the distribution of X (e.g., samples of the total transmit output power) is not gaussian and then more moments (theoretically an infinite number) will be useful to more accurately and reliably approximate the distribution function of X. Using this approach, a distribution function is determined and a P(X<=x) can be computed which accurately and reliably determines the admission and/or congestion threshold for the present invention. The distribution function of X is related to its moments by a formula known as the moment generating function. The system could be configured so that a determination of the number of moments to use can be manually set or automatically self configured in real time.

In any case, the estimated first, second, and any higher order moments are sent periodically to the admission control estimator 415, with period TR. Some exemplary settings for various parameters above include Tₛ =20 ms, and τ=1.25 sec, and T_{R}=2 sec. Then, at step 530, the admission control threshold estimator 415 may determine the maximum tolerable total transmit power based on the selected available K moments (e.g., the first and second moments), the required pilot signal ratio, the pilot signal transmit power, and a predetermined probability of system outage (due to excessive output power). The admission control function may be configured with the required Pilot(Ec/Ior)min, and P_{PIL}. It is noteworthy that when operating below such Pilot(Ec/Ior)min ratio, demodulator performance of the mobile stations 105 may be negatively affected by the phase noise and channel estimation errors. In any case, when using the Pilot(Ec/Ior)min and P_{PIL}, the maximum tolerable total transmit power is:

$${P}_{TX , max} = \frac{{P}_{PIL}}{{Pilot \frac{{E}_{c}}{{I}_{or}} \vert}_{min}} . \qquad \text{Eq. 1-4}$$

The probability of outage is:

$${P}_{OUTAGE} = Pr {\{ Pilot \frac{{E}_{c}}{{I}_{or}} \leq Pilot \frac{{E}_{c}}{{I}_{or}} \vert}_{min} \} = Pr \{ {P}_{TX} \geq {P}_{TX , MAX} \} \qquad \text{Eq. 1-5}$$

At time n, the blocking threshold is computed as the average value that the total transmit power should have for the outage probability to be less or equal than P_{OUTAGE}, given that the total transmit power variance is equal to the measured σ_{P}_{_{TX}}²(n). That is, one must compute μ(n) equal to the maximum μ such that

$$Prob \{ {P}_{TX} \geq {P}_{TX , MAX} ; given μ , {σ}_{{P}_{TX}}^{2} ( n ) \} \approx Q ( \frac{{P}_{TX , MAX} - μ}{{σ}_{{P}_{TX}} ( n )} ) \leq {P}_{OUTAGE} \qquad \text{Eq. 1-6}$$

where the distribution of the total transmit power may be approximated to be, for example, a normal gaussian distribution. In the case where a gaussian approximation and the σ_{P}_{_{TX}}²(n) estimation error are used, in a preferred embodiment μ(n) may be filtered instead of using it directly as the new admission threshold used by admission control (as explained below). Thus, at step 535, the maximum total transmit power threshold is filtered by an admission control threshold filter 420 to determine the new blocking threshold that may be used for dynamic admission and/or congestion control. For example, a simple and robust filter with constant value slew rate, SR[dB] may be selected having function such that:

$$\hat{μ} ( n ) = \{ \begin{matrix}\hat{μ} ( n - 1 ) - SR & if μ ( n ) \leq \hat{μ} ( n - 1 ) \\ \hat{μ} ( n - 1 ) + SR & otherwise\end{matrix} . \qquad \text{Eq. 1-7}$$

where \hat{μ}(n) [dBm] is the value of the blocking threshold computed at time n−1. An even more conservative approach may include limiting the \hat{μ}(n) variations within a pre-defined range which will compensate for a reasonable range of variation in mobile station traffic over which a predetermined outage probability may be maintained. Setting such a range may be used as a fail safe. Suitable setting of the admission control parameters may be determined experimentally based on field tests. For example, field test might be expected to indicate that the admission and/or congestion control function may perform well if Pilot(Ec/Ior)min were in the range of approximately −12 to approximately −10 dB and the outage probability were selected to be in the range of approximately 5% to approximately 20%.

Next, at step 540, the residual capacity estimator 425 determines the residual base station transmit power. This may be provided in response to an admission control process requests for traffic channel setup received by, for example, the call control entity (e.g., call control 225, call manager 340). In that case, upon receipt of a request, the residual capacity estimator 425 may compute the residual forward link capacity, as in:

C_{TX}(n)=\hat{μ}(n)−\hat{P}_{TX}(n). Eq. 1-8

Then, at step 545, if the residual capacity is greater than the average transmit power required to setup the traffic channel, the admission/congestion controller 430 grants the request for admission. Otherwise the request is denied. Thus, the admission/congestion controller 430, by virtue of its dynamic automated adaptive blocking threshold, is now able to block incoming resource requests whenever the residual capacity, that corresponds to a predetermined desired maximum outage probability, is equal or close to zero. However, this does not prevent transmit power over capacity from occurring due to changes in the total transmit power needed to support existing traffic (i.e., congestion).

Finally, at step 550, if the load increase due to increase transmit power of all pre-existing active connections then admission/congestion controller 430 may take corrective action. In such cases the residual capacity may become negative and congestion controller needs to take actions. The congestion control function receives periodic updates of the residual capacity, C_{TX}(n). When the residual capacity is negative, it may, for example, start a counter. The counter may be reset if, for example, the residual capacity becomes positive for one or more configurable time intervals T_{R}. When the counter reaches a configurable threshold, that may be, for example, manually input into the system by the system administrator, congestion control is triggered. The admission/congestion controller 430 may then inform the call control mechanism (e.g., call control 225, call manager 340, etc.) which then may initiate load shedding. Given the exemplary values used above, a reasonable setting of the counter threshold may be in the range of 2 to 4; that is, latency of the congestion detector is in the order of 4 to 8 seconds.

Using the processes described above applied to the embodiment of FIG. 3, the CDMA admission and congestion control system of the present invention operates such that the transmit power sampler 322 may send the K'th moment estimator 324 a sample of the base station transmit power. The K'th moment estimator 324 may collect multiple transmit power samples using power information from the transmit power sampler 322, each sample taken over a predetermined time period during which the total power is relatively unchanged. For example, each transmit power sample may be measured over the time period of a power control group (e.g., 1.25 ms); i.e., during an interval in which the forward link closed loop power control function is not changing the transmission power of the individual forward link traffic channels that make up, together with the pilot channel, the aggregate base station transmit signal. In this time period the transmission power will be relatively unchanged except for changes in the chip-level peak to average power of the CDMA signal.

Then, the K'th moment estimator 324 may use a predetermined number of power samples to dynamically estimate the first K moments (K=1, 2, . . . n) of the transmit power to determine the optimum admission and/or congestion thresholds to be used by the system given the present state of transmission signals and mobile station locations. For K=1 the average base station transmission power is dynamically determined in real time and used by the threshold estimator 322 and the capacity estimator 334 to reset the admission threshold and/or congestion threshold. In the case of K=2, the real time average base station transmission power and the variance of the base station transmission power are dynamically determined and used by the threshold estimator 332 and the capacity estimator 334 to reset the admission threshold and/or congestion threshold. For example, using the first two moments, the average and variance of the base station transmission power, the threshold estimator 332 and the capacity estimator 334 are able to dynamically set a threshold(s) based on a desired outage probability that takes into consideration both the contemporary instantaneous average transmission power and a deviation (e.g., 2-3 standard deviations) from the average transmission power of the base station. Additional moments other then the average and variance may be used to dynamically set the threshold(s); for example [please insert some examples.] In other words, the threshold estimator 332 may dynamically compute contemporary admission control thresholds based on the average value the base station transmission power should have for the outage probability to be equal a desired outage probability, given the estimated K moments (e.g., K=2).

In any case, the dynamically generated contemporary admission control thresholds and/or congestion control thresholds are provided to the admission controller 342 to determine whether more traffic channels (i.e., mobile stations) may be set up on the base station transceiver (i.e., admission) or a congestion controller (not shown) to determine whether a number of presently set up traffic channels should be shed from the base station transceiver. For example, in the case of a request for mobile station admission, the capacity estimator 334 may use the contemporary admission control threshold to compared against the estimated first moment of the base station transmission power to compute the residual base station capacity. The residual base station capacity may then be used by the admission controller 342 to determine whether to add one or more mobile stations and their respective traffic channels to the base station transmitter total transmission power, based on contemporary system traffic experience. As a result, the present invention is capable of providing a more efficient method for obtaining a desired quality of service with optimum signal power capacity utilization based on a desired maximum outage probability. The base station control system can dynamically self-configure its admission and/or congestion thresholds to meet a desired configurable, albeit fixed, outage probability.

Although particular embodiments of the present invention have been shown and described, it will be understood that it is not intended to limit the invention to the preferred embodiments disclosed herein and it will be obvious to those skilled in the art that various changes and modifications may be made without departing from the spirit and scope of the present invention. Thus, the invention is intended to cover alternatives, modifications, and equivalents, which may be included within the spirit and scope of the invention as defined by the claims.

All publications, patents, and patent applications cited herein are hereby incorporated by reference in their entirety for all purposes.

What is claimed is:

1. An communication system, comprising:
a base station control system that dynamically adjusts a maximum output power threshold according to a specified system outage probability so as to compensate for variations in mobile traffic characteristics experienced by a base station over time.

2. The system of claim 1, wherein said maximum output power threshold is an admission threshold or a congestion threshold

3. The system of claim 1, wherein said base station control system includes a transmit power K'th moment estimator for determining one or more moments of a group of total transmit power samples.

4. The system of claim 3, wherein said moments include an average total transmit power of a base station and a variance of a plurality of average total transmit power of the base station.

5. The system of claim 4, wherein said base station control system further includes a transmit power detector coupled to the transmit power K'th moment estimator, the transmit power detector sampling the total transmit power of the base station at predetermined intervals and providing the samples to the transmit power K'th moment estimator.

6. The system of claim 5, wherein said base station control system further includes an admission control threshold estimator that is coupled to said transmit power K'th moment estimator and dynamically determines an admission threshold based on the average total transmit power of a base station and the variance of a plurality of average total transmit power.

7. The system of claim 6, wherein said base station control system further includes a residual capacity estimator that is coupled to said admission control threshold estimator and said transmit power K'th moment estimator, and determines a residual capacity of the base station from the dynamically determined admission threshold.

8. The system of claim 7, wherein said base station control system further includes an admission controller that is coupled to said residual capacity estimator and controls request for additional mobile station traffic.

9. The system of claim 8, wherein said base station control system further includes a congestion controller that is coupled to said residual capacity estimator and controls congestion reduction of mobile station traffic presently active on the base station.

10. The system of claim 9, wherein said base station control system further includes an admission control threshold filter that is coupled to said admission control threshold estimator and said residual capacity estimator, and filters and the admission threshold to reduce estimation errors.

11. The system of claim 10, wherein said communication system uses code division multiple access (CDMA).

12. A communication system, comprising:
a transmit power K'th moment estimator.

13. The system of claim 12, further comprising a threshold estimator coupled to said transmit power K'th moment estimator.

14. The system of claim 13, further comprising a capacity estimator coupled to said threshold estimator.

15. The system of claim 14, further comprising an admission controller coupled to said capacity estimator.

16. The system of claim 15, wherein said system dynamically adjusts an admission threshold in real time for a predetermined system outage probability so as to self-configure a maximum system traffic according to changes in mobile traffic characteristics.

17. The system of claim 15, further comprising a congestion controller wherein said system dynamically adjusts a congestion threshold in real time for a predetermined system outage probability so as to self-configure a maximum system traffic according to changes in mobile traffic characteristics.

18. A method, comprising the step of:
adjusting automatically a maximum output power threshold of a base station transmitter in real time according to a specified system outage probability using a control system configured to self-configure said maximum output power threshold so as to compensate for variations in mobile traffic characteristics experienced by said base station over time.

19. The method of claim 18, wherein said maximum output power threshold is an admission threshold or a congestion threshold

20. The method of claim 19, wherein said step of adjusting automatically includes the step of sampling base station total transmit power to obtain a group of contemporary total transmit power samples.

21. The method of claim 20, wherein said step of adjusting automatically further includes the step of determining one or more moments (K) of said group of contemporary total transmit power samples.

22. The method of claim 21, wherein said step of adjusting automatically further includes the step of determining maximum tolerable total transmit power based upon selected available moments of the group of contemporary total transmit power samples.

23. The method of claim 22, wherein said step of adjusting automatically further includes the step of filtering the maximum tolerable total transmit power.

24. The method of claim 23, wherein said step of adjusting automatically further includes the step of determining a residual base station transmit power.

25. The method of claim 24, further including the step of admitting new mobile stations to said base station if sufficient residual power capacity exists.

26. The method of claim 25, further including the step of taking corrective congestion control actions if there is insufficient residual power capacity.
